(19) United States
(12) Patent Application Publication
(10) Pub. No.: US 2005/0071431 A1
(43) Pub. Date: Mar. 31, 2005

(54) Method of receiving email by electronic communication device

(75) Inventors: Cheng Shing Lai, Taipei Hsien (TW); Chang Liu, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei Hsien (TW)

(21) Appl. No.: 10/671,687

(22) Filed: Sep. 29, 2003

(51) Int. Cl. G06F 15/16

(52) U.S. Cl. 709/206

(57) ABSTRACT

The present invention discloses a method of receiving email by electronic communication device, which uses a mail server to connect to at least one electronic communication device via a network and store at least one notice condition. Such notice condition corresponds to an electronic device; if such mail server discovers a new mail, the mail server will determine whether or not the mail matches the notice condition. If the email is determined as one matching with the notice condition, then the mail server will find out the corresponding electronic communication device according to the notice condition, and send out a notice message to the corresponding electronic communication device. The notice message allows users to know that a new email is stored in the mail server.

### BACKGROUND OF THE INVENTION

1. Field of the Invention

The present invention relates to a method of receiving an email by an electronic communication device, more particularly to method of receiving an email by timely informing the receiver about the arrival of such email.

2. Description of the Related Art

In recent years, the design and development of electronic communication devices not only tend to be light, thin, and compact to meet the market trend, but their functions and applications also fully satisfy consumer's requirements. Thus, electronic communication devices are gradually integrated with the general consumer products to produce a multi-functional electronic communication device. For example, a mobile phone is integrated with a personal digital assistant (PDA) to provide a PDA with a mobile phone function. If such product is integrated with a modem, then it will become a mobile phone with an Internet transmission function, which allows users to connect to Internet for browsing websites or receiving emails. There are plenty of ideas for the design of this sort.

However, no matter how innovative these ideas are, the method of receiving emails by electronic communication devices requires users to turn on a modem and connect to the Internet from time to time. The Internet is connected to an email server that matches with the user account preset in the electronic communication device, and then receives the content of the email from the mail server via Internet. If the user has a very important email delivered to the mail server and if the user has not turned on the modern to logon the Internet, this method will not timely notice the user about the content of such email, and thus delaying precious time or causing unnecessary damages.

### SUMMARY OF THE INVENTION

In view of the shortcomings of the traditional electronic device that cannot timely notice the arrival of important emails or determine if an email has been sent to the mail server, the inventor of the present invention conducted a series of researches and experiments, and finally invented a method of receiving email by electronic communication device in accordance with this invention. Such method includes at least one notice condition in a mail server, so that when a new email arrives, the mail server will determine if such email has a condition matching with the notice condition, and then will immediately send out a notice message to the corresponding electronic communication device. Such arrangement can reduce the chance of not receiving emails timely.

The primary objective of the present invention is to provide a method of receiving emails and informing the receiver about the arrival of new emails.

### BRIEF DESCRIPTION OF THE DRAWINGS

Other features and advantages of the present invention will become apparent in the following detailed description of the preferred embodiments with reference to the accompanying drawings, in which:

FIG. 1 is an illustrative diagram of the structure between the mail server and the electronic communication device according to the present invention.

FIG. 2 is a flow chart of the processing procedure of the mail server according to the present invention.

FIG. 3 is a flow chart of the processing procedure of the electronic communication device according to the present invention.

### DETAILED DESCRIPTION OF THE PREFERRED EMBODIMENTS

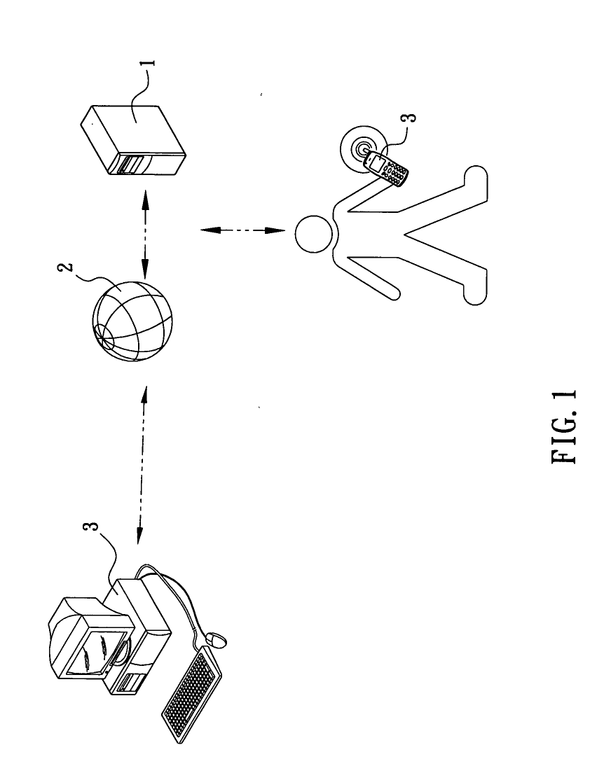

Please refer to FIG. 1 for the present invention. This invention discloses a method of receiving email by electronic communication device, which uses a mail server 1 to connect to at least one electronic communication device 3 via a network 2 and store at least one notice condition. Such notice condition corresponds to an electronic device; if such mail server 1 finds a new email, the mail server 1 will determine whether or not the email matches the notice condition. If such email is determined as one matching with the notice condition, then the mail server 1 will find out the corresponding electronic communication device 3 according to the notice condition, and will send out a notice message to the corresponding electronic communication device 3. The notice message lets users know about a new email being stored in the mail server 1.

In a preferred embodiment of the present invention, the electronic communication device 3 can set the notice condition in the mail server 1 via the network 2, and the notice conditions set in the mail server 1 of the electronic communication device 3 include a mail account, a password, a telephone number of the electronic communication device that receives the notice message, a key information, and the content of a notice message; wherein the key information could be a sender, an email account, or at least one specific character, etc; the notice message could be a sender, an email account, at least one specific character, time of receiving email, mail title, or summary of mail, etc.

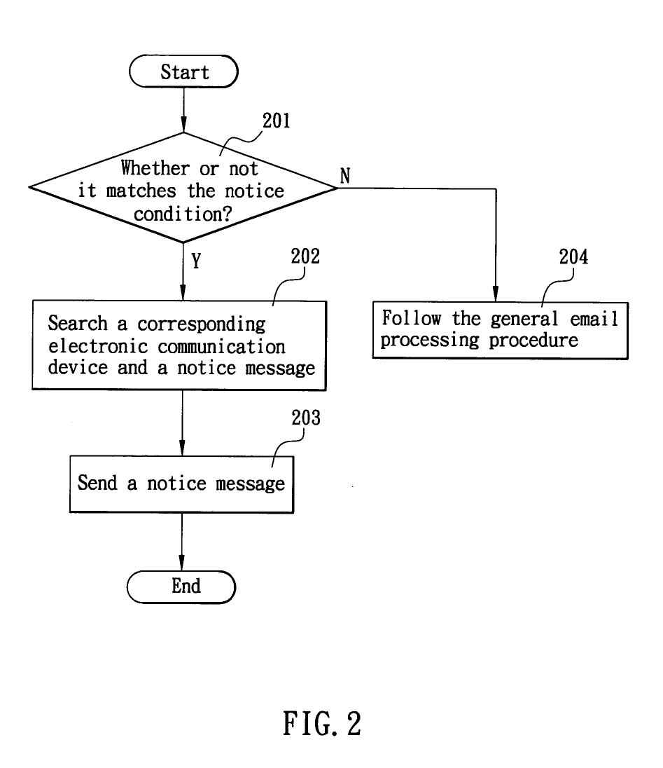

Please refer to FIGS. 1 and 2 for the present invention. When the mail server 1 finds a new email, the mail server 1 will process the following steps:
Step (201): Firstly, the mail server will determine the content included in the email whether or not it matches the notice condition stored in the mail server 1. If yes, then it will process Step (202), or else Step (204);
Step (202): The mail server searches a corresponding electronic communication device 3 and a corresponding notice message according to the notice condition;
Step (203): The mail server sends the notice message to the corresponding electronic communication device 3;
Step (204): The mail server processes the email as in the general procedure.

Before the mail server 1 sends the notice message to the corresponding electronic communication device 3, the mail server 1 will convert the notice message into a message of predetermined format first, and then such message is sent to the corresponding electronic communication device 3. When the electronic communication device 3 receives such message, the electronic device will process the message as the ordinary mode by issuing a beep to the loudspeaker of the electronic communication device, or displaying an icon on the screen of the electronic communication device, so that after the user hears the beep or sees the icon, the user can read the message and get the information of having a new email in the mail server 1 that matches with the notice condition. Such arrangement can reduce the chance of unable to receive the email timely.

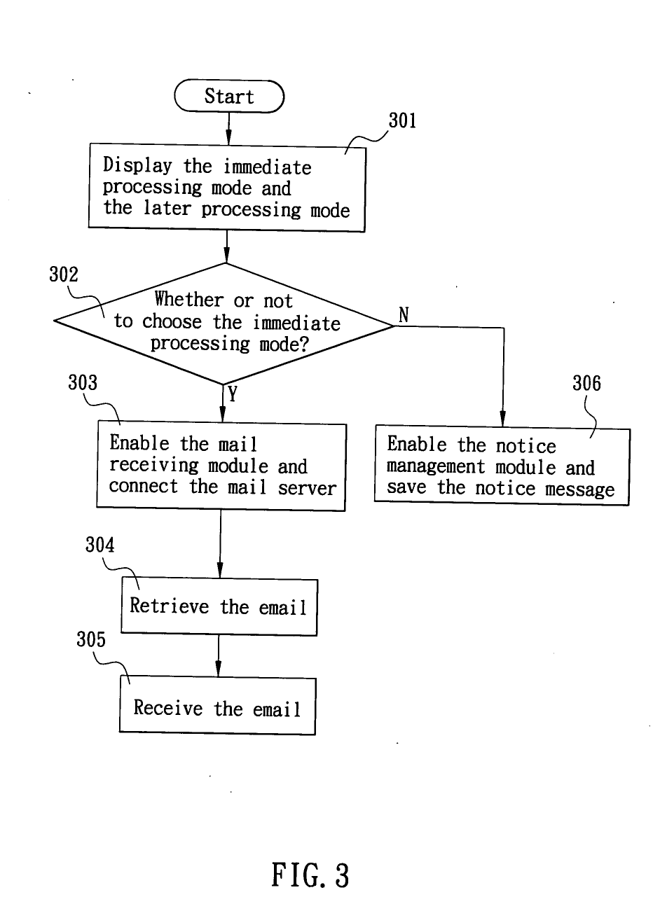

Please refer to FIGS. 1, 2, and 3 for the present invention. After the notice message is sent to the corresponding electronic communication device 3 and the notice message is read, the electronic communication device 3 will process the following steps:
Step (301): Firstly, the electronic communication device 3 shows an operating menu, which includes an immediate processing mode and a later processing mode;
Step (302): The electronic communication device 3 determines whether or not to choose the immediate processing mode. If yes, then it will process Step 303, or else Step 306;
Step (303): The electronic communication device 3 will turn on a preset mail receiving module, and such mail receiving module will connect to the mail server 1 via network 2 according to the notice message;
Step (304): The electronic communication device 3 retrieves the email that matches the notice message in the mail server 1 according to the notice message;
Step (305): The electronic communication device 3 receives the email that matches the notice message sent from the mail server 1;
Step (306): The electronic communication device 3 uses its preset notice management module to save the notice message into a storage medium of the electronic communication device 3.

After the notice management module has saved the notice message in the storage medium, the electronic communication device 3 will process according to the read notice message if the management notice module is started and such notice message is read.

In the present invention, the electronic communication device 3 could be a mobile phone or a computer (as shown in FIG. 1), and after such electronic communication device 3 is connected to the mail server 1 via a network 2, the notice management module is used to set up the notice condition in the mail server 1 and save the notice condition in the mail server 1. The notice management module can be used to set up the configuration (such as the IP address or mail receiving setup) of the mail server 1.

While the invention has been described by means of specific embodiments, numerous modifications and variations could be made thereto by those skilled in the art without departing from the scope and spirit of the invention set forth in the claims.

1. A method of receiving email by electronic communication device, wherein a mail server being connected to at least one electronic device via a network, and saving at least one notice condition, and said notice condition individually corresponding to an electronic communication device; when said mail sever finding a new mail in said mail server, said electronic communication device and mail server processing the following steps:
firstly, the mail server determining whether or not said new mail matching said notice condition;
if said new mail matching said notice condition, then said mail server finding out a corresponding electronic communication device according to said notice condition; and sending out a notice message to said corresponding electronic communication device.

2. The method of receiving email by electronic communication device of claim 1, wherein said electronic communication device sets up said notice condition for said mail server via said network.

3. The method of receiving email by electronic communication device of claim 1, wherein said notice condition set in the mail server of the electronic communication device comprises an email account, a password, a telephone number of electronic communication device that receives the notice, a key information, and a notice message.

4. The method of receiving email by electronic communication device of claim 3, wherein said key information comprises a sender, a sender's email account, and at least one specific character.

5. The method of receiving email by electronic communication device of claim 3, wherein said notice message comprises a sender, a sender's email account, at least one specific character, time of receiving mail, mail title, and mail summary.

6. The method of receiving email by electronic communication device of claim 1, wherein said mail server processes the following steps after detecting a new mail:
firstly, determining whether or not the content of the email matching a notice condition saved in said mail server;
if the email matching the notice condition saved in said mail server, then a corresponding electronic communication device and a notice message being searched according to said notice condition; and
sending said notice message to said corresponding electronic communication device.

7. The method of receiving email by electronic communication device of claim 6, wherein, when said email has content not matching the notice condition saved in said mail server, said mail server processes a general email processing procedure.

8. The method of receiving email by electronic communication device of claim 6, wherein said mail server converts said notice message into a message of preset format and sends said message to said corresponding electronic communication device, before sending said notice message to said corresponding electronic communication device.

9. The method of receiving email by electronic communication device of claim 8, wherein said electronic communication device follows a general message processing mode to issue a beep to a loudspeaker or display an icon on the screen of said electronic communication device when said communication device receives said message.

10. The method of receiving email by electronic communication device of claim 1, wherein said electronic communication device processes said notice message according to the following steps after said notice message is sent to the corresponding electronic communication device and said notice message is read:
firstly, displaying an operating menu on the screen of said electronic communication device, and said operating menu comprising an immediate processing mode and a later processing mode;
determining whether or not to choose the immediate processing mode; if yes, a mail receiving module preset in said electronic communication device being enabled, and said mail receiving module being connected to said mail server according to said notice message via network;
retrieving an email matching with the notice message from said mail server according to said notice message; and
receiving an email matching with the notice message sent from said mail server.

11. The method of receiving email by electronic communication device of claim 10, wherein, when said later processing mode is chosen, a notice management module preset in said electronic communication device is used to save said notice message in a storage medium of said electronic communication device.

12. The method of receiving email by electronic communication device of claim 11, wherein said electronic communication device processes the procedure read from the notice message after said notice management module saves said notice message in said storage medium, provided said notice management module is enabled and said notice message is read.

13. The method of receiving email by electronic communication device of claim 1, wherein said electronic communication device is a mobile phone, and after said mobile phone connects to said mail server via network, said mobile phone uses a notice management module to set said notice condition in said mail server, and saves said notice condition in said mail server, and uses said notice management module to configure the receiving mail server.
